(19) United States
(12) Patent Application Publication
(10) Pub. No.: US 2007/0150838 A1
(43) Pub. Date: Jun. 28, 2007

(54) Method and System for Finding and Visually Highlighting HTML Code by Directly Clicking in the Web Page

(75) Inventor: Peter T. Moser, Carlsbad, CA (US)

Correspondence Address: PROCOPIO, CORY, HARGREAVES & SAVITCH LLP, 530 B STREET, SUITE 2100, SAN DIEGO, CA, 92101, US

(73) Assignee: IEWATCH SOFTWARE LLC, Carlsbad, CA (US)

(21) Appl. No.: 11/617,652

(22) Filed: Dec. 28, 2006

Related U.S. Application Data
(60) Provisional application No. 60/754,336, filed on Dec. 28, 2005.

(51) Int. Cl. G06F 3/048; G06F 17/00; G06F 17/30

(52) U.S. Cl. 715/822; 715/530; 715/513; 715/764; 715/781; 707/6

(57) ABSTRACT

The present invention is directed to a method and system for finding and visually highlighting HTML code by directly clicking in the web page. According to one embodiment of the present invention, an event interface of each browser Document Object Model (“DOM”) element that is rendered on the web page is connected to. The DOM element HTML code is retrieved when a mouse click event on the web page occurs. The element HTML code is highlighted in the code window by finding a directly matching string sequence or using a string matching algorithm.

### CROSS REFERENCE TO RELATED APPLICATIONS

This application claims priority to and herein incorporates by reference U.S. Provisional Patent Application No. 60/754,336 entitled “METHOD AND SYSTEM FOR FINDING AND VISUALLY HIGHLIGHTING HTML CODE BY DIRECTLY CLICKING IN THE WEB PAGE,” filed on Dec., 28, 2005.

### FIELD OF THE INVENTION

The present invention relates generally to computer programming using the hyper-text markup language (“HTML”).

### BACKGROUND

HTML code can be difficult to work with. The HTML instruction set is designed to build web pages. Web pages are used, in part, in a visual manner wherein the web page is loaded by a browser, parsed, and presented visually to a user who has requested the web page.

The web page may have items in different locations on the screen and each of the items are presented and/or built by a number of HTML commands. The HTML commands do not logically correspond to what is seen on the screen by the user.

For example, the web page, when presented in a browser may show an image with a link in the upper left-hand corner of the screen. The HTML code that implements the picture with the link, however, may be located in lines 700-710 of an HTML text document that the browser is parsing. If there is an error in the HTML code implementing the picture with the link, it will be difficult for a user to find in the code, to ascertain its function, and to fix the problem. For at least that reason, HTML coding can be difficult and cumbersome.

### SUMMARY

The present invention is directed to a method and system for finding and visually highlighting HTML code by directly clicking in a web page. According to an embodiment, the HTML code of any visible web page section is found by directly clicking in the browser page. The HTML code is then highlighted and scrolled into view.

According to one embodiment of the present invention, an event interface of each browser Document Object Model (“DOM”) element that may be rendered on the web page is connected to. The DOM element HTML code may be retrieved when a mouse click event on the web page occurs. The element HTML code may be highlighted in the code window by finding a directly matching string sequence or using a string matching algorithm.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a screenshot illustrating an example of a highlighted HTML code according to an embodiment of the present invention.

FIG. 2 is a screenshot illustrating an example of a highlighted HTML table cell according to an embodiment of the present invention.

FIG. 3 is a block diagram illustrating an example system for finding and visually highlighting HTML code by directly clicking in a web page according to an embodiment of the present invention.

FIG. 4 is a diagram illustrating an example process for finding and visually highlighting HTML code by directly clicking in a web page according to an embodiment of the present invention.

FIG. 5 is a diagram illustrating an example process for finding and visually highlighting HTML code by directly clicking in a web page according to an embodiment of the present invention.

FIG. 6 is a block diagram illustrating an example computer system that may be used in connection with various embodiments described herein.

### DETAILED DESCRIPTION

Certain embodiments as disclosed herein provide for a method and system for finding and visually highlighting HTML code by directly clicking in a web page. According to an embodiment, the HTML code of any visible web page section is found by directly clicking in the browser page. The HTML code is then highlighted and scrolled into view.

For example, one method as disclosed herein allows for connecting to an event interface of each browser Document Object Model (“DOM”) element that is rendered on the web page. The DOM element HTML code may be retrieved when a mouse click event on the web page occurs. The element HTML code may be highlighted in the code window by finding a directly matching string sequence or using a string matching algorithm.

Those of skill will further appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit without departing from the invention.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

Those of skill will further appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit without departing from the invention.

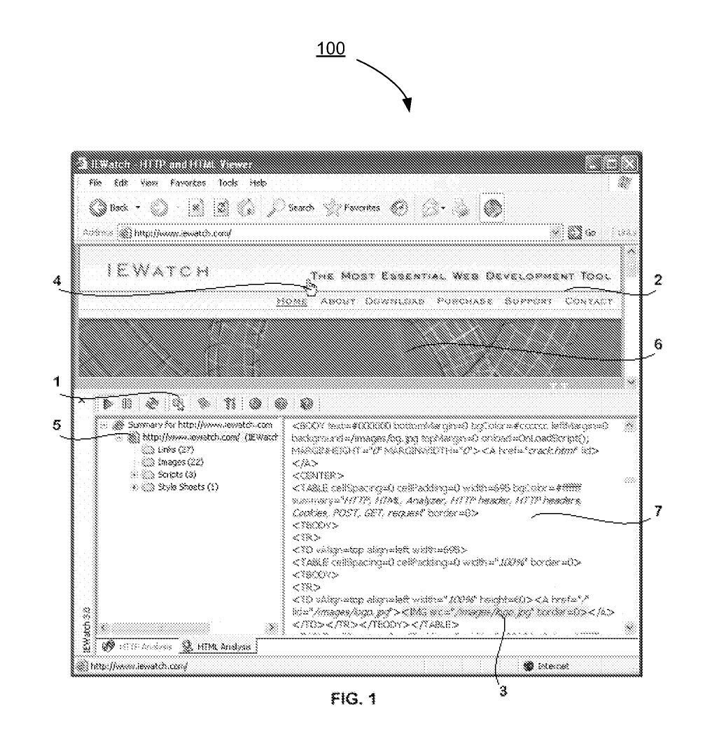

Referring now to the Figures, FIG. 1 is a screen 100 illustrating an example of a highlighted HTML code according to an embodiment of the present invention. The screen 100 includes a button 1, a highlight 2, a highlight 3, a mouse pointer 4, a hierarchical web page tree view 5, a rendered web page 6, and a code window 7.

The button 1 may be used to activate an HTML highlight mode (also referred to as an HTML spotlight mode). The highlight 2 may be used to highlight an element in the browser page. For example, a red border may be drawn around the image. The highlight 3 may be used to highlight the HTML code in the code window 7. The mouse pointer 4 may be used to select the web page section to be highlighted in the HTML code. The hierarchical web page tree view 5 may be used to select a document node. The rendered web page 6 may be used to present a visual indication of the look and feel of the web page built around the current HTML code. The code window 7 may include, for example, HTML code that is used to construct the web page in a browser.

In the example of FIG. 1 the application is implemented as a plug-in window in the lower part of the browser window but the application could also be running in a separate window outside of the browser window. In operation, a user may activate the HTML highlight mode (currently referred to as HTML spotlight mode) by clicking on the (toolbar) button 1. Now the user is enabled to use the mouse pointer 4 to select (or click on) any part of the rendered web page 6 to find the HTML code associated with the clicked section in the browser window. Clicking on the rendered web page 6 may draw the border 2 around the HTML element(s), and also highlight the HTML code 3 in the code window 7. For example, in FIG. 1 the user has positioned the mouse pointer 4 over an image in an upper portion of the rendered web page 6, which in turn causes the application to present the highlight 3, which corresponds to the HTML code associated with the image in the upper portion of the rendered web page 6.

Therefore, using the interface provided in the screen 100 allows the user to find any visible HTML element(s) in the code window 7 by directly clicking in the rendered web page 6. In one embodiment, selecting the button 1 in the toolbar again exits the HTML spotlight mode.

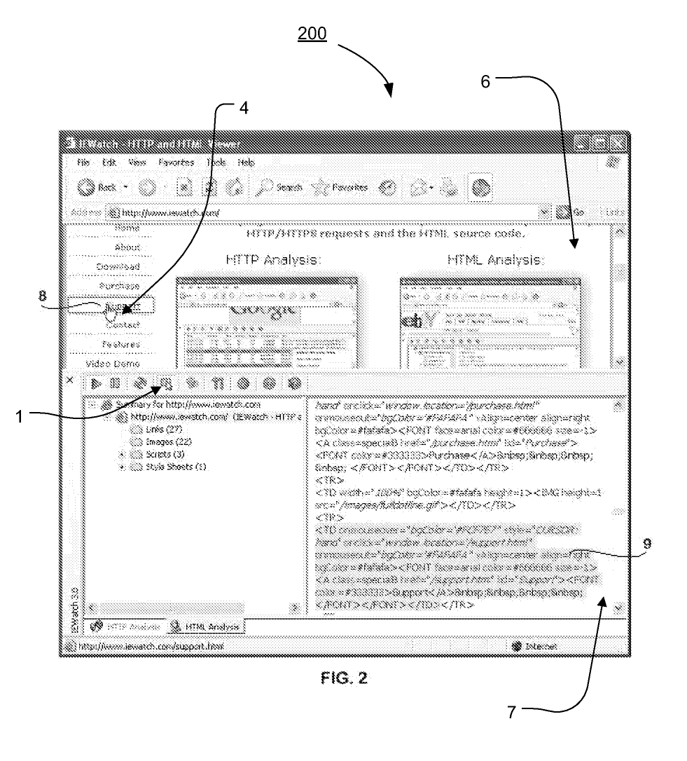

FIG. 2 is a screen 200 illustrating an example of a highlighted HTML table cell according to an embodiment of the present invention. The screen 200 includes a button 1, a mouse pointer 4, a rendered web page 6, a code window 7, a highlight 8, and a highlight 9.

As with FIG. 1, the button 1 may be used to activate an HTML highlight mode (also referred to as an HTML spotlight mode). The highlight 8 may be used to highlight an element in the rendered web page 6. For example, in FIG. 2, the user has been enabled to select an element of a table in the rendered web page 6, so the highlight 8 is red border that is drawn around the table element.

The highlight 9 may be used to highlight the HTML code in the code window 7. The mouse pointer 4 may be used to select the web page section to be highlighted in the HTML code. The code window 7 may include, for example, HTML code that is used to construct the web page in a browser.

In the example of FIG. 2 the application is implemented as a plug-in window in the lower part of the browser window but the application could also be running in a separate window outside of the browser window. In operation, a user may activate the HTML highlight mode (currently referred to as HTML spotlight mode) by clicking on the (toolbar) button 1. Now the user is enabled to use the mouse pointer 4 to select (or click on) any part of the rendered web page 6 to find the HTML code associated with the clicked section in the browser window. Clicking on the rendered web page 6 may draw a border around the HTML element(s) (the highlight 8), and also cause the highlight 9 to appear around the HTML code in the code window 7. For example, in FIG. 1 the user has positioned the mouse pointer 4 over a table in a left-hand portion of the rendered web page 6, which in turn causes the application to present the highlight 3, which corresponds to the HTML code associated with the table element in the left-hand portion of the rendered web page 6.

Therefore, using the interface provided in the screen 200 allows the user to find any visible HTML element(s) in the code window 7 by directly clicking in the rendered web page 6. In one embodiment, selecting the button 1 in the toolbar again exits the HTML spotlight mode.

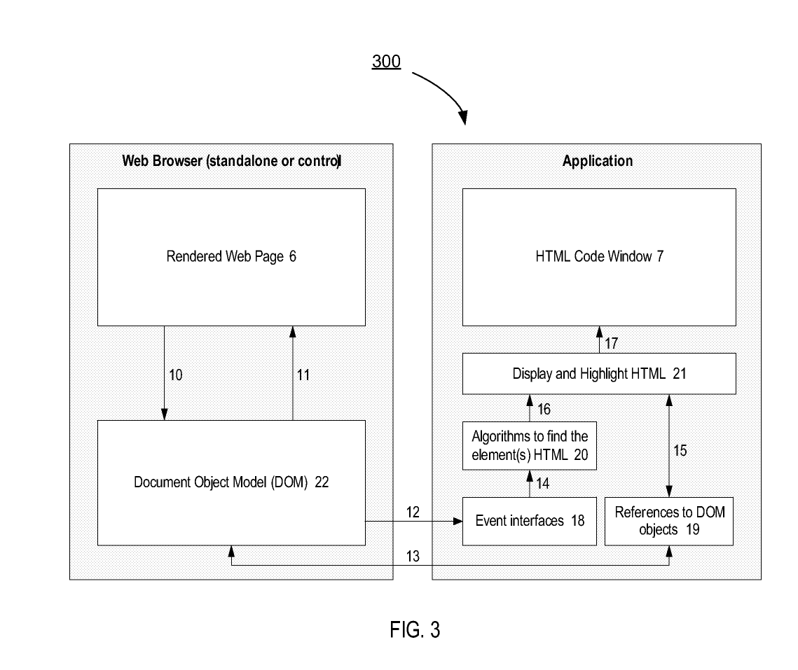

FIG. 3 is a block diagram illustrating an example system 300 for finding and visually highlighting HTML code by directly clicking in a web page according to an embodiment of the present invention. The system 300 includes a rendered web page 6, and a code window 7, data paths 10, 11, 12, 13, 14, 15, 16, and 17, an event interface 18, references to DOM objects 19, algorithms 20, a code module 21, and a DOM module 22.

The data path 10 may be used to transfer click events from the rendered web page 6 to the DOM module 22. The data path 11 may be used to highlight clicked HTML element(s) in the rendered web page 6. The data path 12 may be used to receive an object reference to a clicked DOM element. The data path 13 may be used to hold references to the rendered DOM elements. The data path 14 may be used to initiate highlighting by transferring the HTML code of the clicked element(s). The data path 15 may be used to update DOM objects and highlight element(s) in web page. The data path 16 may be used to pass the position in the document code of the matching HTML code section. The data path 17 may be used to display HTML and highlight the matching section in the HTML code window 7.

The event interface 18 may be used for event sink interfaces that receive click notifications from the web browser. The references to DOM objects 19 may be hierarchical structures that hold references to the rendered DOM objects. The algorithms 20 may be a series of instructions that may be used to find the matching position of the element(s) HTML code in the code window 7. The code module 21 may be configured to display and highlight the HTML in the code window.

In operation, the code window 7 may display the HTML code associated with the rendered web page 6. The code window 7 either displays the rendered HTML from a DOM document node or the HTML code that has been retrieved directly from a web server (e.g., through a hyper-text transfer protocol (“HTTP”) request). The code module 21 may be used to display and highlight HTML in the code window 7. The code module 21 may use references to the DOM objects 19 and events from the code module 21 that contain the algorithms 20 to find the matching HTML code section.

The event interfaces 18 may receive notifications on the data path 12 from the browser DOM elements 22 about click events on the rendered web page 6. A border may be drawn around the clicked web page element(s) to visually highlight it. This may be accomplished by inserting an HTML DIV element into the DOM causing the browser to draw a border around the clicked HTML element using the data path 11.

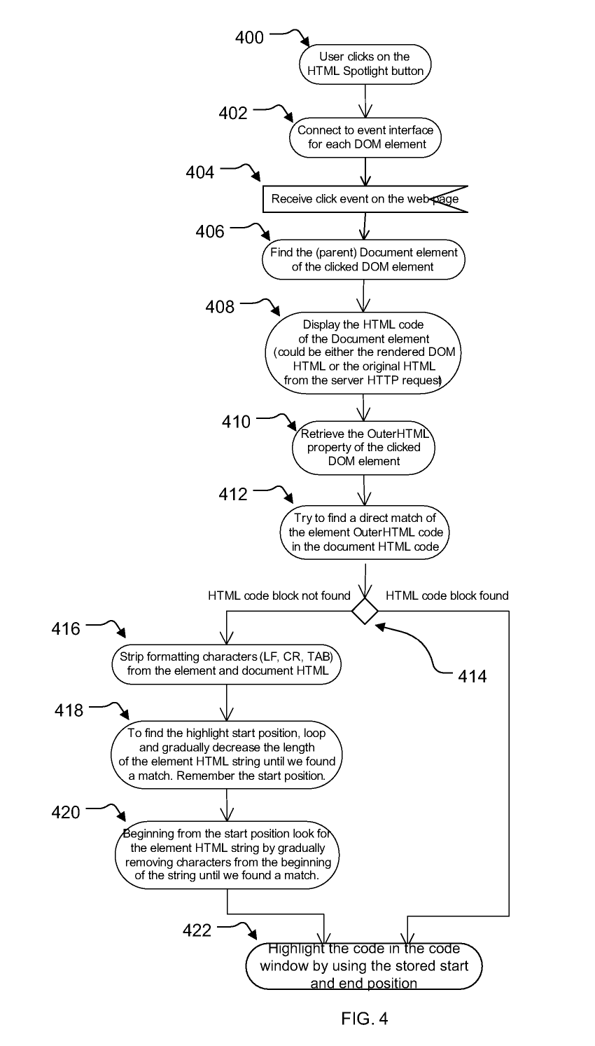

FIG. 4 is a diagram illustrating an example process for finding and visually highlighting HTML code by directly clicking in a web page according to an embodiment of the present invention. This process can be carried out by the system 300 previously described with respect to FIG. 3. In the illustrated example, a user clicks on an HTML spotlight button at step 400. The HTML spotlight button may be a component of a user interface, for example, as described with respect to the button 1 shown in FIGS. 1 and 2.

At step 402, for each DOM element, an event interface is connected to. At step 404, a click event is received on the web page. For example, a user may be enabled to use a mouse on the screen and may click on some sub-portion of the rendered web page. Then, at step 406, the parent document element for the clicked on DOM element is found.

At step 408, the HTML code of the document element is displayed. This could be, for instance, the rendered DOM HTML or the original HTML from a server HTTP request. At step 410, the outer HTML properties for the clicked on DOM element are retrieved. Then, at step 412, the system tries to find a direct match for the element outer HTML code in the document HTML code.

At step 414, the system determines whether or not the HTML code block is found. If the HTML code block is not found, formatting characters are stripped from the element and the document HTML at step 416. The formatting characters may include, for example, “LF,” “CR,” and “TAB”. Then at step 418, the highlight start position is obtained. This may be implemented, for example, using a loop wherein the length of the element HTML string is gradually decreased until a match is found. The start position is then remembered.

Next, at step 420, using the remembered start position, the element HTML string is searched for. This may be implemented in a number of manners. In one embodiment, the HTML string search algorithm gradually decreases (reverse) the length of the element HTML string until a match is found. For example, a relatively long string starting at the start position (or a string to the end of the document starting from the remembered start position) is gradually reduced until the end position of the string being looked for is found. In other embodiments, other methods may be used to locate the string that the system is trying to match. For example, beginning from the start position, characters can gradually be removed from the beginning of the string until a match is found. Thereafter, at step 422 the code is highlighted in the code window by remembering the start and end positions of the element HTML string. If, on the other hand, the HTML code block is found, at step 414, flow proceeds directly to step 422.

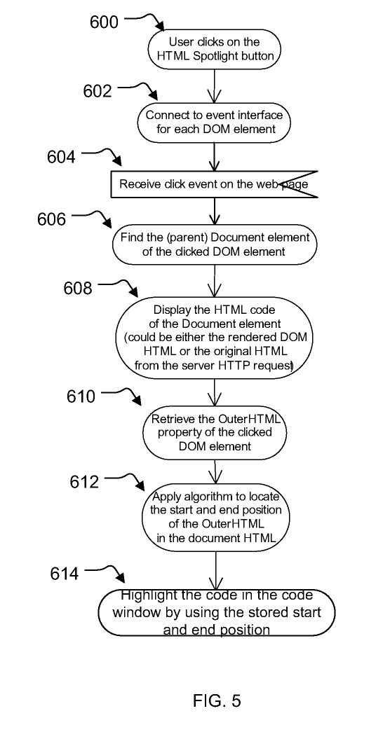

FIG. 5 is another diagram illustrating an example process for finding and visually highlighting HTML code by directly clicking in a web page according to an embodiment of the present invention. This process can be carried out by the system 300 previously described with respect to FIG. 3. In the illustrated example, a user clicks on an HTML spotlight button at step 600. The HTML spotlight button may be a component of a user interface, for example, as described with respect to the button 1 shown in FIGS. 1 and 2.

At step 602, for each DOM element, an event interface is connected to. At step 604, a click event is received on the web page. For example, a user may be enabled to use a mouse on the screen and may click on some sub-portion of the rendered web page. Then, at step 606, the parent document element for the clicked on DOM element is found.

At step 608, the HTML code of the document element is displayed. This could be, for instance, the rendered DOM HTML or the original HTML from a server HTTP request. At step 610, the outer HTML properties for the clicked on DOM element are retrieved. Then, at step 612, an algorithm is applied. The algorithm may be configured to locate a start and an end position of the outer HTML in the document HTML, for example. Thereafter, at step 614 the code is highlighted in the code window by remembering the start and end positions of the element HTML string.

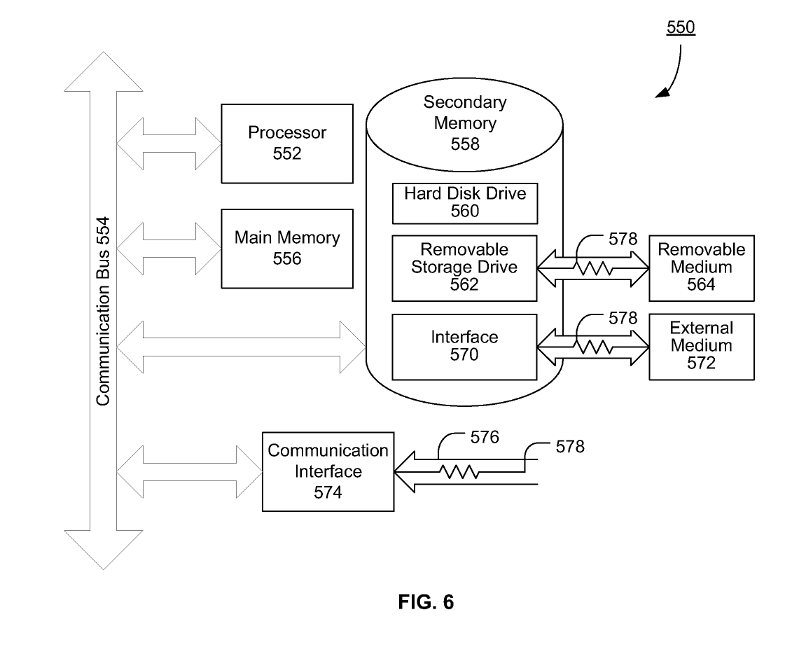

FIG. 6 is a block diagram illustrating an example computer system 550 that may be used in connection with various embodiments described herein. For example, the computer system 550 may be used in the display of the HTML code of any visible web page section, which may be found by directly clicking in a browser page. The HTML code may then be highlighted and scrolled into view. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for visually highlighting hyper-text markup language (“HTML”) code compromising:
connecting to an event interface of a document object model (“DOM”) element that is rendered on a web page;
retrieving an HTML code associated with the DOM element when a mouse click event on the web page occurs; and
highlighting the HTML code in a code window.

2. The method of claim 1 wherein the step of highlighting further comprises finding a directly matching string sequence for the HTML code.

3. The method of claim 1 wherein the step of highlighting further comprises using a string matching algorithm to retrieve the HTML code.

4. A system for visually highlighting hyper-text markup language (“HTML”) code compromising:
an event interface;
a document object model (“DOM”) element that is rendered on a web page that is configured to be connected to the event interface;
HTML code associated with the DOM element that is configured to be retrieved when a mouse click event on the web page occurs; and
a highlight associated with the HTML code, which is configured to be displayed in a code window

5. The system of claim 4 further comprising an algorithm configured to be used to find a directly matching string sequence for the HTML code.

6. The system of claim 4 further comprising a string matching algorithm configured to be used to find the HTML code.
